(19) United States
(12) Patent Application Publication
(10) Pub. No.: US 2025/0293514 A1
(43) Pub. Date: Sep. 18, 2025

(54) POWER SUPPLY SYSTEM, MOVING OBJECT, AND CONTROL METHOD OF POWER SUPPLY SYSTEM

(71) Applicant: HONDA MOTOR CO., LTD., Tokyo (JP)

(72) Inventor: Hisao Haga, Wako-shi (JP)

(21) Appl. No.: 19/074,872

(22) Filed: Mar. 10, 2025

(30) Foreign Application Priority Data
Mar. 14, 2024 (JP) 2024-040182

(51) Int. Cl. H02J 1/08; G05B 15/02; H02J 1/10

(52) U.S. Cl. CPC H02J 1/084; G05B 15/02; H02J 1/106

(57) ABSTRACT

A power supply system includes: a first power supply circuit for supplying DC power from a first power generation device to a first load device; a first power storage device connected to the first power supply circuit; a second power supply circuit for supplying the DC power from the first power generation device to a second load device; and a second power storage device connected to the second power supply circuit. In a case where supply of DC power from the first power storage device to the first load device is cut off, DC power is supplied to the first load device from the second power storage device by allowing the current backflow in the second power supply circuit.

### CROSS-REFERENCE TO RELATED APPLICATIONS

This application is based upon and claims the benefit of priority from Japanese Patent Application No. 2024-040182 filed on Mar. 14, 2024, the contents of which are incorporated herein by reference.

### BACKGROUND OF THE INVENTION

### Field of the Invention

The present disclosure relates to a power supply system, a moving object, and a control method of the power supply system.

### Description of the Related Art

JP 2022-529997 A discloses an aircraft electrical energy supply network (power supply system).

### SUMMARY OF THE INVENTION

There has been a demand for a more satisfactory power supply system, a moving object including the more satisfactory power supply system, and a more satisfactory control method of the power supply system.

The present invention has the object of solving the aforementioned problem.

According to a first aspect of the present disclosure, there is provided a power supply system comprising: a first power supply circuit configured to supply, to a first load device, direct current electric power output from a first power generation device; a first power storage device connected to the first power supply circuit in parallel with the first power generation device; a second power supply circuit including a backflow preventing element configured to prevent a current backflow, and a backflow allowing element configured to allow the current backflow, the second power supply circuit being configured to supply, to a second load device, the direct current electric power output from the first power generation device; a second power storage device connected to the second power supply circuit in parallel with the first power generation device; and a control device configured to control the backflow allowing element, wherein, in a case where supply of direct current electric power from the first power storage device to the first load device is cut off, the control device controls the backflow allowing element to allow the current backflow in the second power supply circuit, thereby supplying direct current electric power to the first load device from the second power storage device via the second power supply circuit.

According to a second aspect of the present disclosure, there is provided a moving object comprising the power supply system according to the first aspect.

According to a third aspect of the present disclosure, there is provided a control method of a power supply system, the power supply system including: a first power supply circuit configured to supply, to a first load device, direct current electric power output from a first power generation device; a first power storage device connected to the first power supply circuit in parallel with the first power generation device; a second power supply circuit including a backflow preventing element configured to prevent a current backflow, and a backflow allowing element configured to allow the current backflow, the second power supply circuit being configured to supply, to a second load device, the direct current electric power output from the first power generation device; a second power storage device connected to the second power supply circuit in parallel with the first power generation device; and a control device configured to control the backflow allowing element, the control method comprising, in a case where supply of direct current electric power from the first power storage device to the first load device is cut off, causing the control device to control the backflow allowing element to allow the current backflow in the second power supply circuit, thereby supplying direct current electric power to the first load device from the second power storage device via the second power supply circuit.

According to the present invention, it is possible to provide a more satisfactory power supply system, a moving object including the more satisfactory power supply system, and a more satisfactory control method of the power supply system.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a power supply system according to a first embodiment;

FIG. 2 is a diagram showing the operation of the power supply system in the normal state in the first embodiment;

FIG. 3 is a time chart showing the transition of energy (electric power) supplied to a first load device, a second load device, a third load device, and a fourth load device in the normal state in the first embodiment;

FIG. 4 is a diagram showing the operation of the power supply system in the event of an abnormality in first embodiment;

FIG. 5 is a time chart showing the transition of energy (electric power) supplied to the first load device, the second load device, the third load device, and the fourth load device in the event of an abnormality in the first embodiment;

FIG. 6 is a control block diagram of a control device in the first embodiment;

FIG. 7 is a flowchart showing fail-safe control in the first embodiment;

FIG. 8 is a diagram showing the operation of the power supply system in the event of an abnormality in a second embodiment;

FIG. 9 is a time chart showing the transition of energy (electric power) supplied to the first load device, the second load device, the third load device, and the fourth load device in the event of an abnormality in the second embodiment;

FIG. 10 is a diagram showing the operation of the power supply system in the event of an abnormality in a comparative example;

FIG. 11 is a time chart showing the transition of energy (electric power) supplied to the first load device, the second load device, the third load device, and the fourth load device in the event of an abnormality in the comparative example;

FIG. 12 is a flowchart showing the fail-safe control in the second embodiment; and

FIG. 13 is a schematic diagram of a moving object according to a third embodiment.

### DETAILED DESCRIPTION OF THE INVENTION

As a power supply system that supplies DC power (direct current electric power) output from a power generation device to a first load device and a second load device, a power supply system has been heretofore proposed which is provided with, as power sources separate from the power generation device, a first power storage device that supplies DC power to the first load device and a second power storage device that supplies DC power to the second load device.

In a case where the required electric power of the first load device and the required electric power of the second load device cannot be satisfied only by the DC power supplied from the power generation device, the DC power is supplied from the first power storage device to the first load device, and the DC power is supplied from the second power storage device to the second load device.

However, in a case where the supply of the DC power from the first power storage device to the first load device is cut off, the DC power supplied to the first load device may be insufficient.

In contrast, in the power supply system of the present disclosure, even in a case where the supply of the DC power from the first power storage device to the first load device is cut off, the supply of sufficient DC power to the first load device can be continued. Hereinafter, the power supply system of the present disclosure will be described.

### First Embodiment

### [Configuration of Power Supply System]

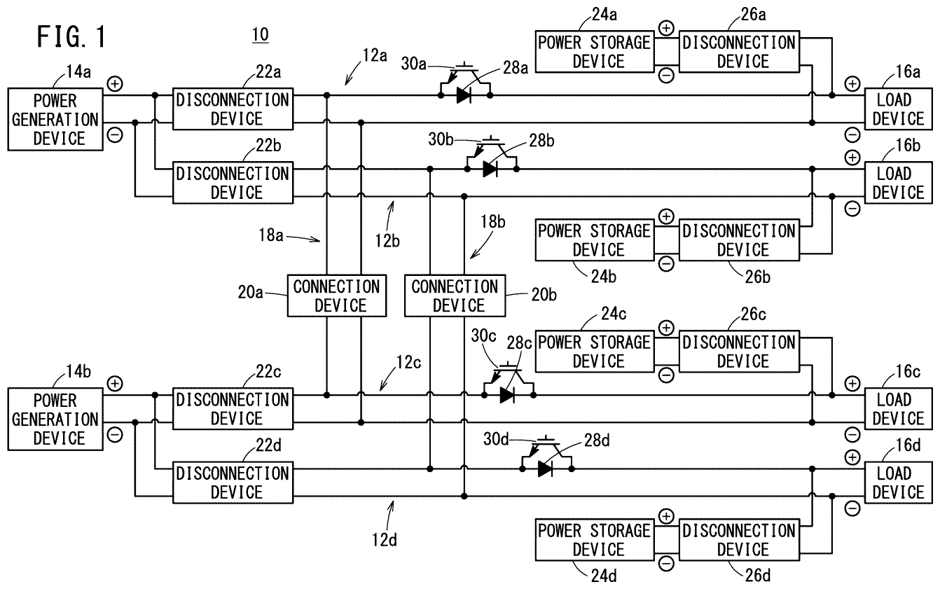

FIG. 1 is a schematic diagram of a power supply system 10 according to a first embodiment. The power supply system 10 includes a first power supply circuit 12a, a second power supply circuit 12b, a third power supply circuit 12c, and a fourth power supply circuit 12d.

The first power supply circuit 12a supplies, to a first load device 16a, DC power output from a first power generation device 14a. The second power supply circuit 12b supplies, to a second load device 16b, the DC power output from the first power generation device 14a. The third power supply circuit 12c supplies, to a third load device 16c, DC power output from a second power generation device 14b. The fourth power supply circuit 12d supplies, to a fourth load device 16d, the DC power output from the second power generation device 14b.

The first power generation device 14a and the second power generation device 14b each include an engine, a generator, and a power control unit (all of them not shown). The engine drives the generator, and the generator generates three-phase AC power. The power control unit converts the three-phase AC power into DC power.

The first power generation device 14a and the second power generation device 14b may each include various sensors such as a voltage sensor and a current sensor, and elements such as a fuse, a relay, a breaker, a diode, a transistor, a resistor, a coil, and a capacitor.

The first load device 16a, the second load device 16b, the third load device 16c, and the fourth load device 16d each include an inverter and an electric motor (both of them not shown). The inverter converts the input DC power into three-phase AC power, and the electric motor is driven by the three-phase AC power. The first load device 16a, the second load device 16b, the third load device 16c, and the fourth load device 16d may each include a DC/DC converter and a low-voltage drive device (both of them not shown). The DC/DC converter lowers the voltage of the input DC power, and the low-voltage drive device is driven by the DC power.

The first load device 16a, the second load device 16b, the third load device 16c, and the fourth load device 16d may each include various sensors such as a voltage sensor and a current sensor, and elements such as a fuse, a relay, a breaker, a diode, a transistor, a resistor, a coil, and a capacitor.

The power supply system 10 includes a first connection circuit 18a and a second connection circuit 18b. The first connection circuit 18a includes a first connection device 20a capable of connecting the first power supply circuit 12a and the third power supply circuit 12c. The second connection circuit 18b includes a second connection device 20b capable of connecting the second power supply circuit 12b and the fourth power supply circuit 12d.

The first connection device 20a and the second connection device 20b each include a contactor. The first connection device 20a and the second connection device 20b may each include a relay. The first connection device 20a and the second connection device 20b may each include a breaker. The first connection device 20a and the second connection device 20b may each include a semiconductor switch.

Normally, the connection between the first power supply circuit 12a and the third power supply circuit 12c is cut off. Thus, in a case where an abnormality occurs in one of the first power supply circuit 12a or the third power supply circuit 12c, the other can be prevented from being affected by the abnormality. For example, in a case where an overcurrent occurs in the first power supply circuit 12a, the overcurrent can be prevented from flowing to the third power supply circuit 12c.

Similarly, the connection between the second power supply circuit 12b and the fourth power supply circuit 12d is normally cut off. Thus, in a case where an abnormality occurs in one of the second power supply circuit 12b or the fourth power supply circuit 12d, the other can be prevented from being affected by the abnormality. For example, in a case where an overcurrent occurs in the second power supply circuit 12b, the overcurrent can be prevented from flowing to the fourth power supply circuit 12d.

In a case where the supply of electric power from the first power generation device 14a to the first power supply circuit 12a is cut off, the first power supply circuit 12a and the third power supply circuit 12c are connected by the first connection device 20a. As a result, electric power is supplied from the second power generation device 14b to the first power supply circuit 12a. Therefore, the supply of electric power to the first load device 16a can be continued.

Further, in a case where the supply of electric power from the first power generation device 14a to the second power supply circuit 12b is cut off, the second power supply circuit 12b and the fourth power supply circuit 12d are connected by the second connection device 20b. As a result, electric power is supplied from the second power generation device 14b to the second power supply circuit 12b. Therefore, the supply of electric power to the second load device 16b can be continued.

Further, in a case where the supply of electric power from the second power generation device 14b to the third power supply circuit 12c is cut off, the first power supply circuit 12a and the third power supply circuit 12c are connected by the first connection device 20a. As a result, electric power is supplied from the first power generation device 14a to the third power supply circuit 12c. Therefore, the supply of electric power to the third load device 16c can be continued.

Further, in a case where the supply of electric power from the second power generation device 14b to the fourth power supply circuit 12d is cut off, the second power supply circuit 12b and the fourth power supply circuit 12d are connected by the second connection device 20b. As a result, electric power is supplied from the first power generation device 14a to the fourth power supply circuit 12d. Therefore, the supply of electric power to the fourth load device 16d can be continued.

The power supply system 10 includes a first disconnection device 22a, a second disconnection device 22b, a third disconnection device 22c, and a fourth disconnection device 22d. The first disconnection device 22a can disconnect the first power generation device 14a from the first power supply circuit 12a and the first connection circuit 18a. The second disconnection device 22b can disconnect the first power generation device 14a from the second power supply circuit 12b and the second connection circuit 18b. The third disconnection device 22c can disconnect the second power generation device 14b from the third power supply circuit 12c and the first connection circuit 18a. The fourth disconnection device 22d can disconnect the second power generation device 14b from the fourth power supply circuit 12d and the second connection circuit 18b.

The first disconnection device 22a, the second disconnection device 22b, the third disconnection device 22c, and the fourth disconnection device 22d each include a contactor. The first disconnection device 22a, the second disconnection device 22b, the third disconnection device 22c, and the fourth disconnection device 22d may each include a relay. The first disconnection device 22a, the second disconnection device 22b, the third disconnection device 22c, and the fourth disconnection device 22d may each include a breaker. The first disconnection device 22a, the second disconnection device 22b, the third disconnection device 22c, and the fourth disconnection device 22d may each include a semiconductor switch.

The power supply system 10 includes a first power storage device 24a, a second power storage device 24b, a third power storage device 24c, and a fourth power storage device 24d. The first power storage device 24a is connected to the first power supply circuit 12a in parallel with the first power generation device 14a. The second power storage device 24b is connected to the second power supply circuit 12b in parallel with the first power generation device 14a. The third power storage device 24c is connected to the third power supply circuit 12c in parallel with the second power generation device 14b. The fourth power storage device 24d is connected to the fourth power supply circuit 12d in parallel with the second power generation device 14b.

The first power storage device 24a, the second power storage device 24b, the third power storage device 24c, and the fourth power storage device 24d each include a lithium ion battery. The first power storage device 24a, the second power storage device 24b, the third power storage device 24c, and the fourth power storage device 24d may each include a secondary battery other than the lithium ion battery. The first power storage device 24a, the second power storage device 24b, the third power storage device 24c, and the fourth power storage device 24d may each include a large-capacity capacitor.

The first power storage device 24a, the second power storage device 24b, the third power storage device 24c, and the fourth power storage device 24d may each include various sensors such as a voltage sensor and a current sensor, and elements such as a fuse, a relay, a breaker, a diode, a transistor, a resistor, a coil, and a capacitor.

The power supply system 10 includes a fifth disconnection device 26a, a sixth disconnection device 26b, a seventh disconnection device 26c, and an eighth disconnection device 26d. The fifth disconnection device 26a can disconnect the first power storage device 24a from the first power supply circuit 12a and the first connection circuit 18a. The sixth disconnection device 26b can disconnect the second power storage device 24b from the second power supply circuit 12b and the second connection circuit 18b. The seventh disconnection device 26c can disconnect the third power storage device 24c from the third power supply circuit 12c and the first connection circuit 18a. The eighth disconnection device 26d can disconnect the fourth power storage device 24d from the fourth power supply circuit 12d and the second connection circuit 18b.

The fifth disconnection device 26a, the sixth disconnection device 26b, the seventh disconnection device 26c, and the eighth disconnection device 26d each include a contactor. The fifth disconnection device 26a, the sixth disconnection device 26b, the seventh disconnection device 26c, and the eighth disconnection device 26d may each include a relay. The fifth disconnection device 26a, the sixth disconnection device 26b, the seventh disconnection device 26c, and the eighth disconnection device 26d may each include a breaker. The fifth disconnection device 26a, the sixth disconnection device 26b, the seventh disconnection device 26c, and the eighth disconnection device 26d may each include a semiconductor switch.

The power supply system 10 includes a first backflow preventing element 28a, a second backflow preventing element 28b, a third backflow preventing element 28c, and a fourth backflow preventing element 28d. The power supply system 10 further includes a first backflow allowing element 30a, a second backflow allowing element 30b, a third backflow allowing element 30c, and a fourth backflow allowing element 30d.

The first backflow preventing element 28a is a diode provided on the positive wire of the first power supply circuit 12a. The first backflow allowing element 30a is an insulated gate bipolar transistor (hereinafter, referred to as IGBT) provided on a wire bypassing the first backflow preventing element 28a.

In a case where the first backflow allowing element 30a is “OFF”, the first backflow preventing element 28a prevents a current backflow in the first power supply circuit 12a. In a case where the first backflow allowing element 30a is “ON”, the first backflow preventing element 28a allows the current backflow in the first power supply circuit 12a.

In this instance, the current backflow (the current flowing backward) in the first power supply circuit 12a indicates a current flowing from the first load device 16a side to the first power generation device 14a side in the positive wire of the first power supply circuit 12a, and a current flowing from the first power generation device 14a side to the first load device 16a side in the negative wire of the first power supply circuit 12a.

The second backflow preventing element 28b is a diode provided on the positive wire of the second power supply circuit 12b. The second backflow allowing element 30b is an IGBT provided on a wire bypassing the second backflow preventing element 28b.

In a case where the second backflow allowing element 30b is “OFF”, the second backflow preventing element 28b prevents a current backflow in the second power supply circuit 12b. In a case where the second backflow allowing element 30b is “ON”, the second backflow preventing element 28b allows the current backflow in the second power supply circuit 12b.

In this instance, the current backflow (the current flowing backward) in the second power supply circuit 12b indicates a current flowing from the second load device 16b side to the first power generation device 14a side in the positive wire of the second power supply circuit 12b, and a current flowing from the first power generation device 14a side to the second load device 16b side in the negative wire of the second power supply circuit 12b.

The third backflow preventing element 28c is a diode provided on the positive wire of the third power supply circuit 12c. The third backflow allowing element 30c is an IGBT provided on a wire bypassing the third backflow preventing element 28c.

In a case where the third backflow allowing element 30c is “OFF”, the third backflow preventing element 28c prevents a current backflow in the third power supply circuit 12c. In a case where the third backflow allowing element 30c is “ON”, the third backflow preventing element 28c allows the current backflow in the third power supply circuit 12c.

In this instance, the current backflow (the current flowing backward) in the third power supply circuit 12c indicates a current flowing from the third load device 16c side to the second power generation device 14b side in the positive wire of the third power supply circuit 12c, and a current flowing from the second power generation device 14b side to the third load device 16c side in the negative wire of the third power supply circuit 12c.

The fourth backflow preventing element 28d is a diode provided on the positive wire of the fourth power supply circuit 12d. The fourth backflow allowing element 30d is an IGBT provided on a wire bypassing the fourth backflow preventing element 28d.

In a case where the fourth backflow allowing element 30d is “OFF”, the fourth backflow preventing element 28d prevents a current backflow in the fourth power supply circuit 12d. In a case where the fourth backflow allowing element 30d is “ON”, the fourth backflow preventing element 28d allows the current backflow in the fourth power supply circuit 12d.

In this instance, the current backflow (the current flowing backward) in the fourth power supply circuit 12d indicates a current flowing from the fourth load device 16d side to the second power generation device 14b side in the positive wire of the fourth power supply circuit 12d, and a current flowing from the second power generation device 14b side to the fourth load device 16d side in the negative wire of the fourth power supply circuit 12d.

### [Operation of Power Supply System in Normal State]

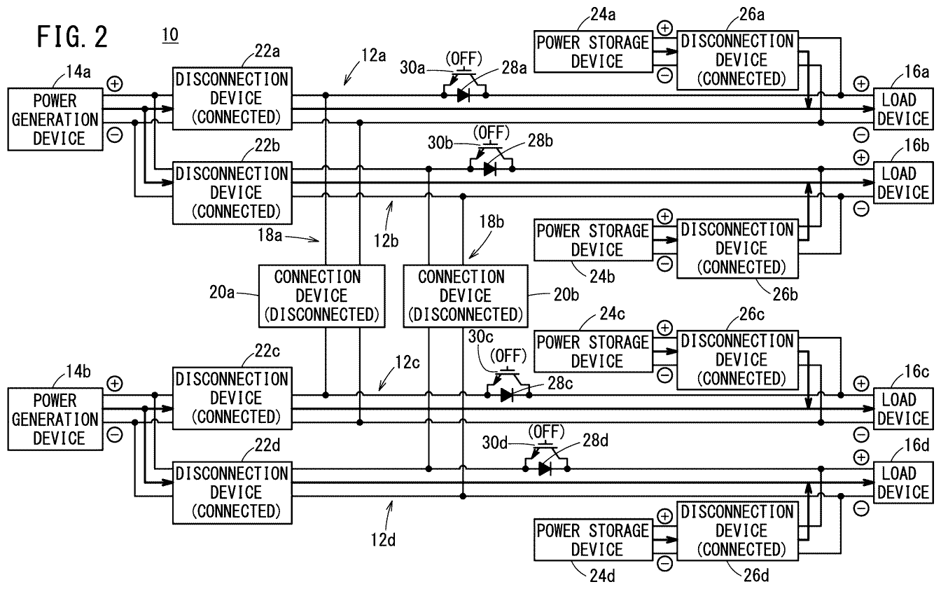

FIG. 2 is a diagram showing the operation of the power supply system 10 in the normal state in the first embodiment. Arrows shown in FIG. 2 indicate electric power supply paths.

The first power generation device 14a is connected to the first power supply circuit 12a by the first disconnection device 22a, and DC power is supplied from the first power generation device 14a to the first load device 16a. The first power generation device 14a is connected to the second power supply circuit 12b by the second disconnection device 22b, and the DC power is supplied from the first power generation device 14a to the second load device 16b. The second power generation device 14b is connected to the third power supply circuit 12c by the third disconnection device 22c, and DC power is supplied from the second power generation device 14b to the third load device 16c. The second power generation device 14b is connected to the fourth power supply circuit 12d by the fourth disconnection device 22d, and the DC power is supplied from the second power generation device 14b to the fourth load device 16d.

The first power storage device 24a is connected to the first load device 16a by the fifth disconnection device 26a, and DC power is supplied from the first power storage device 24a to the first load device 16a. The second power storage device 24b is connected to the second load device 16b by the sixth disconnection device 26b, and DC power is supplied from the second power storage device 24b to the second load device 16b. The third power storage device 24c is connected to the third load device 16c by the seventh disconnection device 26c, and DC power is supplied from the third power storage device 24c to the third load device 16c. The fourth power storage device 24d is connected to the fourth load device 16d by the eighth disconnection device 26d, and DC power is supplied from the fourth power storage device 24d to the fourth load device 16d.

The connection between the first power supply circuit 12a and the third power supply circuit 12c is interrupted by the first connection device 20a, and the connection between the second power supply circuit 12b and the fourth power supply circuit 12d is interrupted by the second connection device 20b.

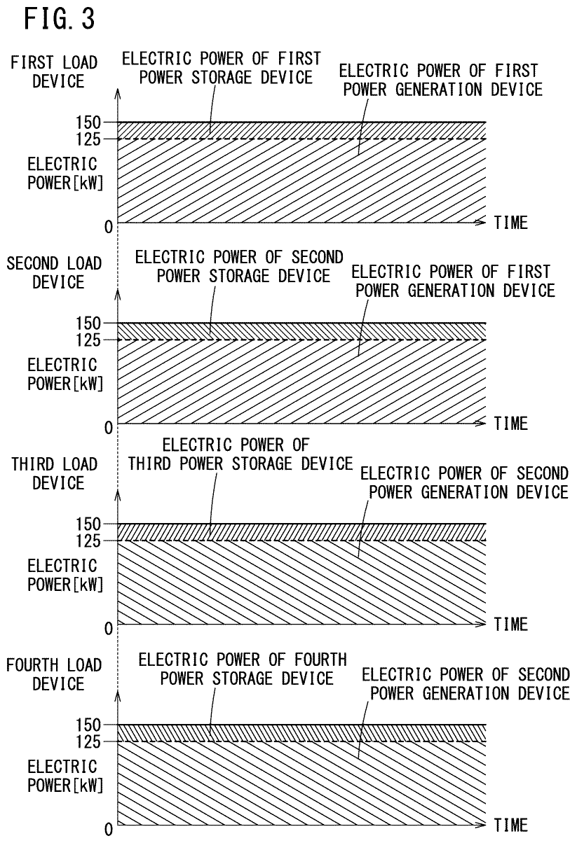

FIG. 3 is a time chart showing the transition of energy (electric power) supplied to the first load device 16a, the second load device 16b, the third load device 16c, and the fourth load device 16d in the normal state in the first embodiment. FIG. 3 schematically shows the transition of the energy.

It is assumed that the rated output of the first power generation device 14a is 250 [kW] and the rated output of the second power generation device 14b is 250 [kW]. Further, it is assumed that the required electric power of each of the first load device 16a, the second load device 16b, the third load device 16c, and the fourth load device 16d is 150 [kW].

In this case, the sum of the required electric power of the first load device 16a and the required electric power of the second load device 16b is 300 [kW], whereas the rated output of the first power generation device 14a is 250 [kW]. Therefore, DC power of 25 [kW] is supplied from the first power storage device 24a to the first load device 16a, and DC power of 25 [kw] is supplied from the second power storage device 24b to the second load device 16b, thereby satisfying the required electric power of the first load device 16a and the required electric power of the second load device 16b.

Similarly, DC power of 25 [kW] is supplied from the third power storage device 24c to the third load device 16c, and DC power of 25 [kW] is supplied from the fourth power storage device 24d to the fourth load device 16d, thereby satisfying the required electric power of the third load device 16c and the required electric power of the fourth load device 16d.

### [Operation of Power Supply System in Event of Abnormality]

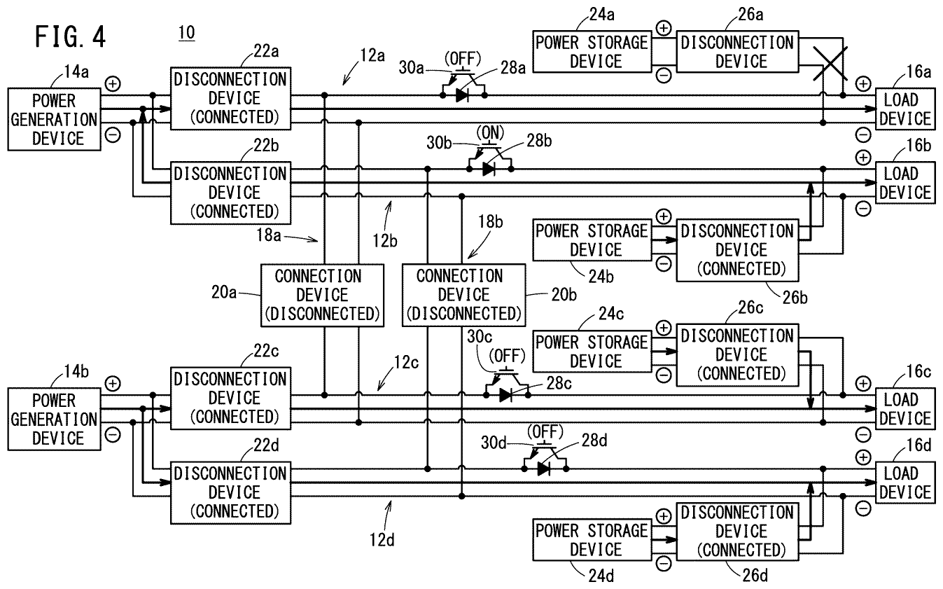

FIG. 4 is a diagram showing the operation of the power supply system 10 in the event of an abnormality in the first embodiment. Arrows shown in FIG. 4 indicate electric power supply paths.

FIG. 4 shows the operation of the power supply system 10 in a case where the supply of DC power from the first power storage device 24a to the first load device 16a is cut off. The state where the supply of the DC power from the first power storage device 24a to the first load device 16a is cut off is, for example, a state where the wire between the first power storage device 24a and the first power supply circuit 12a is disconnected, or a state where the contactor of the fifth disconnection device 26a is fixed in the off state.

In a case where the supply of DC power from the first power storage device 24a to the first load device 16a is cut off, then as shown in FIG. 4, the second backflow allowing element 30b is turned on to allow the current backflow in the second power supply circuit 12b. This enables the supply of DC power from the second power storage device 24b to the first load device 16a via the second power supply circuit 12b.

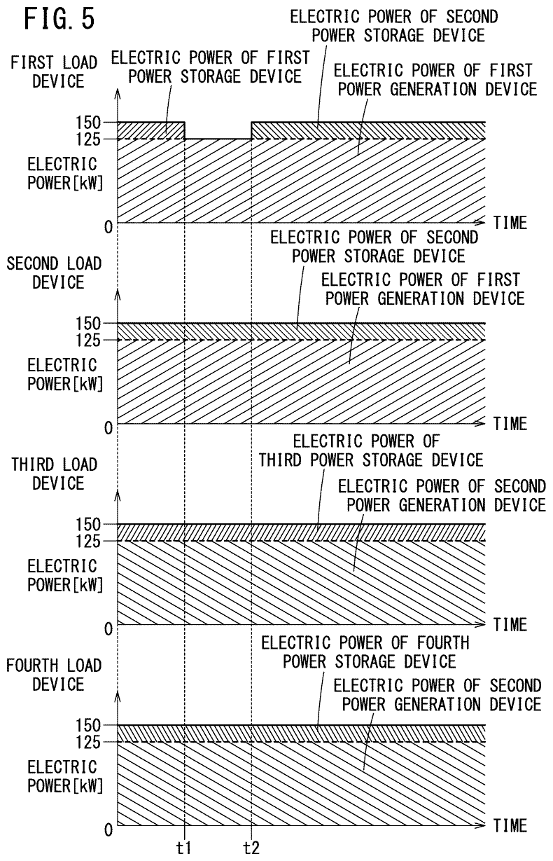

FIG. 5 is a time chart showing the transition of energy (electric power) supplied to the first load device 16a, the second load device 16b, the third load device 16c, and the fourth load device 16d in the event of an abnormality in the first embodiment. FIG. 5 schematically shows the transition of the energy in a case where the supply of DC power from the first power storage device 24a to the first load device 16a is cut off.

At a time point t1 in FIG. 5, it is assumed that the supply of the DC power from the first power storage device 24a to the first load device 16a is cut off. In this case, since only the DC power of 125 [kW] is supplied from the first power generation device 14a to the first load device 16a, electric power of 25 [kW] is insufficient with respect to the required electric power of 150 [kW] of the first load device 16a.

Therefore, in the first embodiment, at a time point t2, the second backflow allowing element 30b is turned on to allow the current backflow in the second power supply circuit 12b. As a result, the DC power of 25 [kW] is supplied from the second power storage device 24b to the first load device 16a, and the required electric power of the first load device 16a is satisfied.

### [Configuration of Control Device]

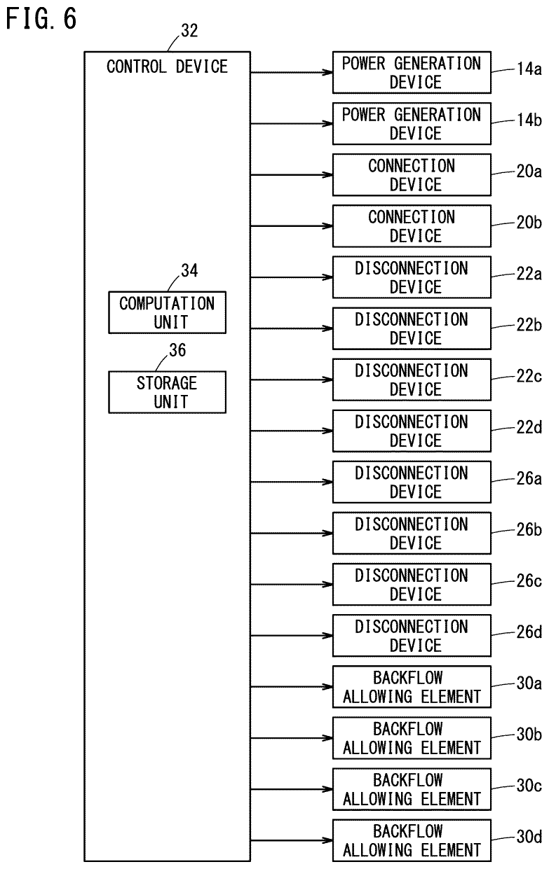

The power supply system 10 includes a control device 32. FIG. 6 is a control block diagram of the control device 32 in the first embodiment.

The control device 32 controls the first power generation device 14a, the second power generation device 14b, the first connection device 20a, the second connection device 20b, the first disconnection device 22a, the second disconnection device 22b, the third disconnection device 22c, the fourth disconnection device 22d, the fifth disconnection device 26a, the sixth disconnection device 26b, the seventh disconnection device 26c, the eighth disconnection device 26d, the first backflow allowing element 30a, the second backflow allowing element 30b, the third backflow allowing element 30c, and the fourth backflow allowing element 30d.

The control device 32 includes a computation unit 34 and a storage unit 36. The computation unit 34 is, for example, a processor such as a central processing unit (CPU) or a graphics processing unit (GPU). The computation unit 34 controls each device by executing a program stored in the storage unit 36. At least part of the computation unit 34 may be realized by an integrated circuit such as an application specific integrated circuit (ASIC) or a field-programmable gate array (FPGA). At least part of the computation unit 34 may be realized by an electronic circuit including a discrete device.

The storage unit 36 is constituted by a volatile memory (not shown) and a non-volatile memory (not shown) which are computer-readable storage media. The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least part of the storage unit 36 may be included in the processor, the integrated circuit, or the like described above.

### [Fail-Safe Control]

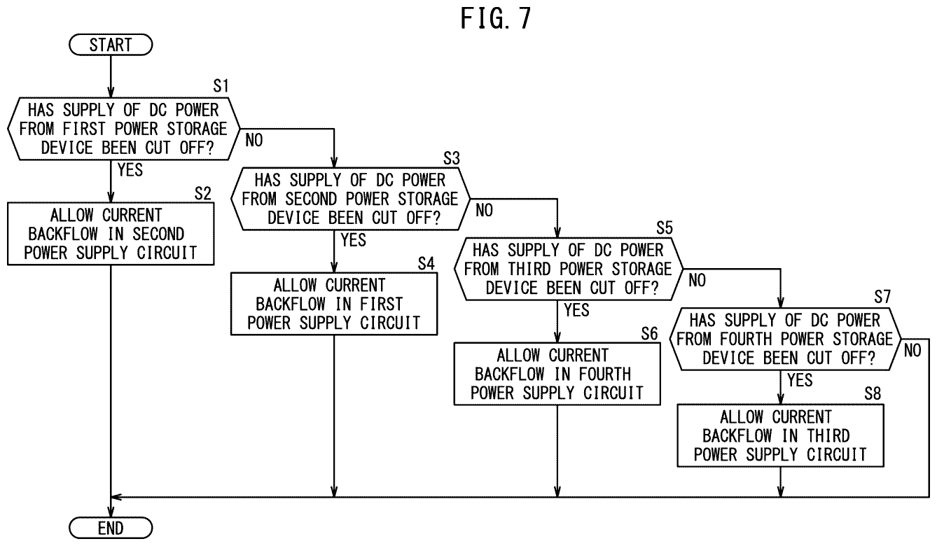

FIG. 7 is a flowchart showing fail-safe control in the first embodiment. The fail-safe control is repeatedly executed at a predetermined cycle in the control device 32.

In step S1, the control device 32 determines whether or not the supply of DC power from the first power storage device 24a to the first load device 16a has been cut off. In a case where it is determined that the supply of the DC power from the first power storage device 24a to the first load device 16a has been cut off (step S1: YES), the process proceeds to step S2.

In step S2, the control device 32 controls the second backflow allowing element 30b to allow the current backflow in the second power supply circuit 12b. Thereafter, the fail-safe control is ended.

In a case where it is determined in step S1 that the DC power is being supplied from the first power storage device 24a to the first load device 16a (step S1: NO), the process proceeds to step S3.

In step S3, the control device 32 determines whether or not the supply of DC power from the second power storage device 24b to the second load device 16b has been cut off. In a case where it is determined that the supply of the DC power from the second power storage device 24b to the second load device 16b has been cut off (step S3: YES), the process proceeds to step S4.

In step S4, the control device 32 controls the first backflow allowing element 30a to allow the current backflow in the first power supply circuit 12a. Thereafter, the fail-safe control is ended.

In a case where it is determined in step S3 that the DC power is being supplied from the second power storage device 24b to the second load device 16b (step S3: NO), the process proceeds to step S5.

In step S5, the control device 32 determines whether or not the supply of DC power from the third power storage device 24c to the third load device 16c has been cut off. In a case where it is determined that the supply of the DC power from the third power storage device 24c to the third load device 16c has been cut off (step S5: YES), the process proceeds to step S6.

In step S6, the control device 32 controls the fourth backflow allowing element 30d to allow the current backflow in the fourth power supply circuit 12d. Thereafter, the fail-safe control is ended.

In a case where it is determined in step S5 that the DC power is being supplied from the third power storage device 24c to the third load device 16c (step S5: NO), the process proceeds to step S7.

In step S7, the control device 32 determines whether or not the supply of DC power from the fourth power storage device 24d to the fourth load device 16d has been cut off. In a case where it is determined that the supply of the DC power from the fourth power storage device 24d to the fourth load device 16d has been cut off (step S7: YES), the process proceeds to step S8.

In step S8, the control device 32 controls the third backflow allowing element 30c to allow the current backflow in the third power supply circuit 12c. Thereafter, the fail-safe control is ended.

In a case where it is determined in step S7 that the DC power is being supplied from the fourth power storage device 24d to the fourth load device 16d (step S7: NO), the fail-safe control is ended.

### Second Embodiment

The configuration of the power supply system 10 of the second embodiment is the same as the configuration of the power supply system 10 of the first embodiment. The fail-safe control executed by the control device 32 of the second embodiment is partially different from the fail-safe control executed by the control device 32 of the first embodiment.

### [Operation of Power Supply System in Event of Abnormality]

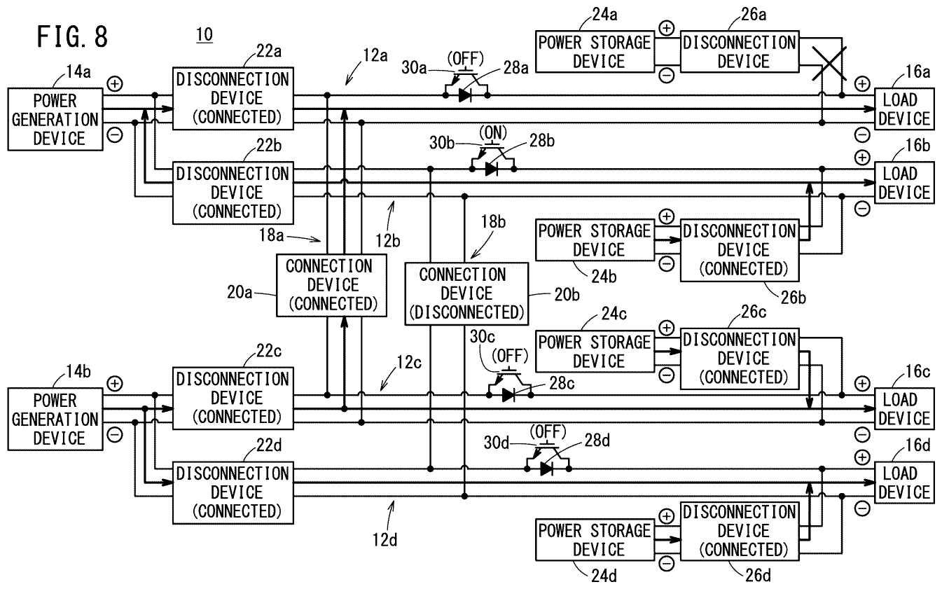

FIG. 8 is a diagram showing the operation of the power supply system 10 in the event of an abnormality in the second embodiment. Arrows shown in FIG. 8 indicate electric power supply paths. FIG. 8 shows the operation of the power supply system 10 in a case where the supply of DC power from the first power storage device 24a to the first load device 16a is cut off.

In a case where the supply of DC power from the first power storage device 24a to the first load device 16a is cut off, then as shown in FIG. 8, the second backflow allowing element 30b is turned on to allow the current backflow in the second power supply circuit 12b. This enables the supply of DC power from the second power storage device 24b to the first load device 16a via the second power supply circuit 12b.

Further, as shown in FIG. 8, the first power supply circuit 12a and the third power supply circuit 12c are connected by the first connection device 20a. This enables the supply of DC power from the second power generation device 14b to the first load device 16a.

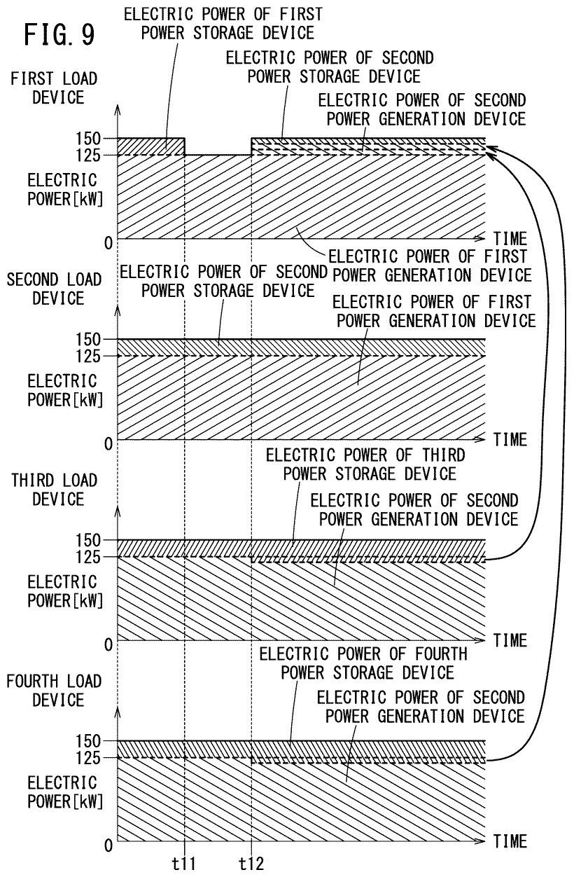

FIG. 9 is a time chart showing the transition of energy (electric power) supplied to the first load device 16a, the second load device 16b, the third load device 16c, and the fourth load device 16d in the event of an abnormality in the second embodiment. FIG. 9 schematically shows the transition of the energy in a case where the supply of DC power from the first power storage device 24a to the first load device 16a is cut off.

At a time point t11 in FIG. 9, it is assumed that the supply of the DC power from the first power storage device 24a to the first load device 16a is cut off. In this case, since only the DC power of 125 [kW] is supplied from the first power generation device 14a to the first load device 16a, electric power of 25 [kW] is insufficient with respect to the required electric power of 150 [kW] of the first load device 16a.

Therefore, in the second embodiment, at a time point t12, the second backflow allowing element 30b is turned on to allow the current backflow in the second power supply circuit 12b. Further, the first power supply circuit 12a and the third power supply circuit 12c are connected by the first connection device 20a. As a result, DC power of 8.3 [kW] is supplied from the second power storage device 24b to the first load device 16a, and DC power of 16.7 [kW] is supplied from the second power generation device 14b to the first load device 16a, so that the required electric power of the first load device 16a is satisfied.

Supplying the DC power from the second power generation device 14b to the first load device 16a reduces the DC power supplied from the second power generation device 14b to the third load device 16c and the fourth load device 16d. However, the DC power supplied from the third power storage device 24c to the third load device 16c increases, and thus the required electric power of the third load device 16c is satisfied. Similarly, the DC power supplied from the fourth power storage device 24d to the fourth load device 16d increases, and thus the required electric power of the fourth load device 16d is satisfied.

### Comparison between Power Supply System of Second Embodiment and Power Supply System of Comparative Example

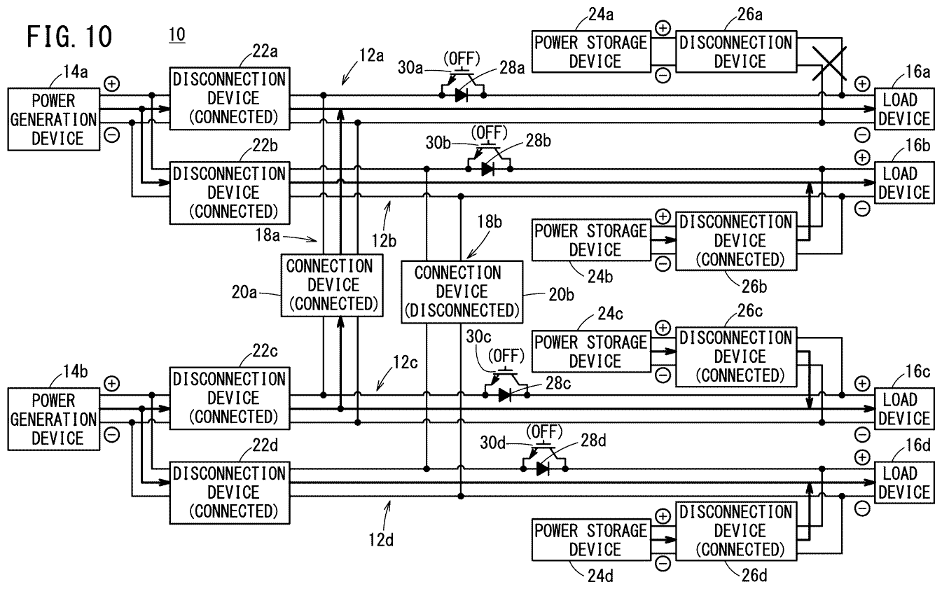

FIG. 10 is a diagram showing the operation of the power supply system 10 in the event of an abnormality in a comparative example. Arrows shown in FIG. 10 indicate electric power supply paths. FIG. 10 shows the operation of the power supply system 10 in a case where the supply of DC power from the first power storage device 24a to the first load device 16a is cut off.

In a case where the supply of the DC power from the first power storage device 24a to the first load device 16a is cut off, then in the comparative example, as shown in FIG. 10, the second backflow allowing element 30b is turned off, unlike the second embodiment. Therefore, DC power is not supplied from the second power storage device 24b to the first load device 16a. In the comparative example, as in the second embodiment, the first power supply circuit 12a and the third power supply circuit 12c are connected by the first connection device 20a as shown in FIG. 10. This enables the supply of DC power from the second power generation device 14b to the first load device 16a.

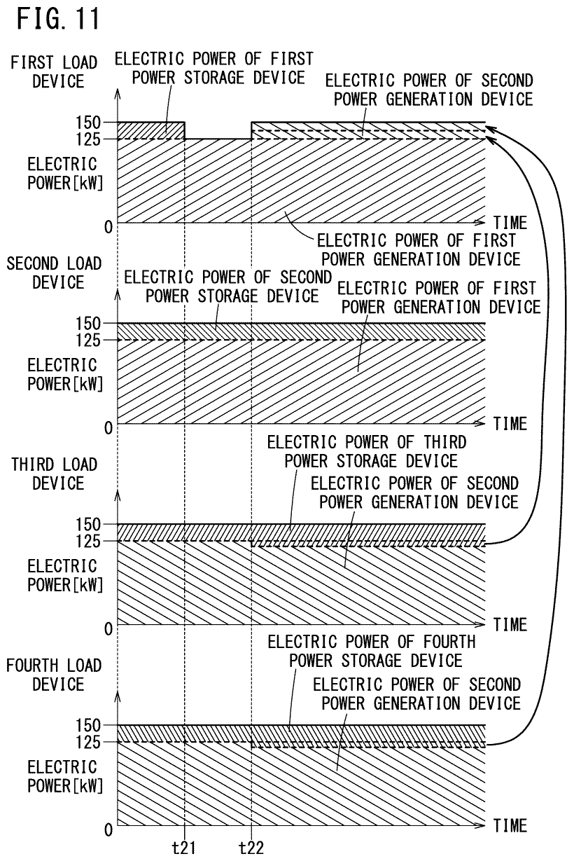

FIG. 11 is a time chart showing the transition of energy (electric power) supplied to the first load device 16a, the second load device 16b, the third load device 16c, and the fourth load device 16d in the event of an abnormality in the comparative example. FIG. 11 schematically shows the transition of the energy in a case where the supply of DC power from the first power storage device 24a to the first load device 16a is cut off.

At a time point t21 in FIG. 11, it is assumed that the supply of the DC power from the first power storage device 24a to the first load device 16a is cut off. In this case, since only the DC power of 125 [kW] is supplied from the first power generation device 14a to the first load device 16a, electric power of 25 [kW] is insufficient with respect to the required electric power of 150 [kW] of the first load device 16a.

In the comparative example, at a time point t22, the first power supply circuit 12a and the third power supply circuit 12c are connected by the first connection device 20a. As a result, DC power of 25 [kW] is supplied from the second power generation device 14b to the first load device 16a, and the required electric power of the first load device 16a is satisfied.

Supplying the DC power from the second power generation device 14b to the first load device 16a reduces the DC power supplied from the second power generation device 14b to the third load device 16c and the fourth load device 16d. However, the DC power supplied from the third power storage device 24c to the third load device 16c increases, and thus the required electric power of the third load device 16c is satisfied. Similarly, the DC power supplied from the fourth power storage device 24d to the fourth load device 16d increases, and thus the required electric power of the fourth load device 16d is satisfied.

In the comparative example, the DC power of each of the third power storage device 24c and the fourth power storage device 24d becomes larger than the DC power of the second power storage device 24b. Therefore, the degree of deterioration of the third power storage device 24c and the fourth power storage device 24d is advanced with respect to the degree of deterioration of the second power storage device 24b.

In the second embodiment, in a case where the supply of the DC power from the first power storage device 24a to the first load device 16a is cut off, the second backflow allowing element 30b is turned on to allow the current backflow in the second power supply circuit 12b as described above.

As a result, in the second embodiment, the DC power of the second power storage device 24b, the DC power of the third power storage device 24c, and the DC power of the fourth power storage device 24d can be substantially equal to each other. Therefore, the difference among the degree of deterioration of the second power storage device 24b, the degree of deterioration of the third power storage device 24c, and the degree of deterioration of the fourth power storage device 24d can be reduced.

### [Fail-Safe Control]

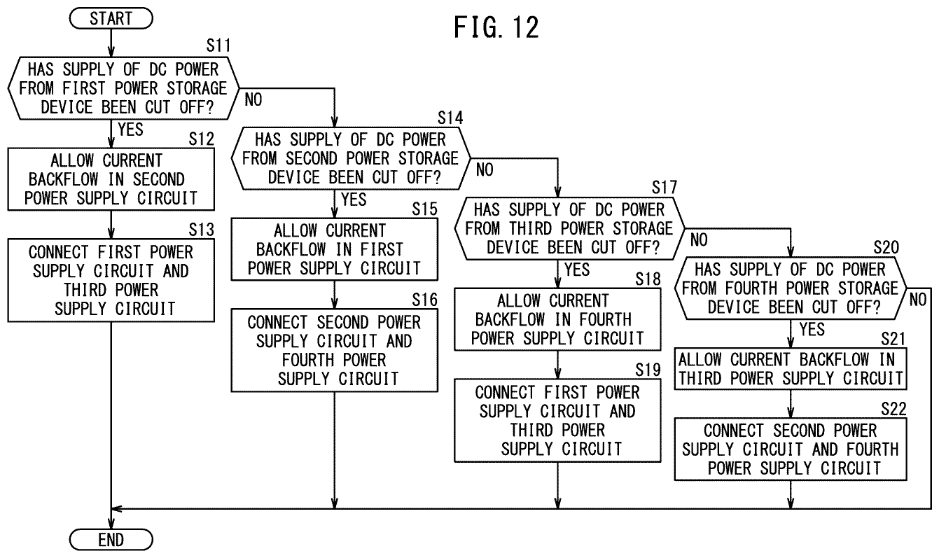

FIG. 12 is a flowchart showing the fail-safe control in the second embodiment. The fail-safe control is repeatedly executed at a predetermined cycle in the control device 32.

In step S11, the control device 32 determines whether or not the supply of DC power from the first power storage device 24a to the first load device 16a has been cut off. In a case where it is determined that the supply of the DC power from the first power storage device 24a to the first load device 16a has been cut off (step S11: YES), the process proceeds to step S12.

In step S12, the control device 32 controls the second backflow allowing element 30b to allow the current backflow in the second power supply circuit 12b. Thereafter, the process proceeds to step S13.

In step S13, the control device 32 controls the first connection device 20a to connect the first power supply circuit 12a and the third power supply circuit 12c. Thereafter, the fail-safe control is ended.

In a case where it is determined in step S11 that the DC power is being supplied from the first power storage device 24a to the first load device 16a (step S11: NO), the process proceeds to step S14.

In step S14, the control device 32 determines whether or not the supply of DC power from the second power storage device 24b to the second load device 16b has been cut off. In a case where it is determined that the supply of the DC power from the second power storage device 24b to the second load device 16b has been cut off (step S14: YES), the process proceeds to step S15.

In step S15, the control device 32 controls the first backflow allowing element 30a to allow the current backflow in the first power supply circuit 12a. Thereafter, the process proceeds to step S16.

In step S16, the control device 32 controls the second connection device 20b to connect the second power supply circuit 12b and the fourth power supply circuit 12d. Thereafter, the fail-safe control is ended.

In a case where it is determined in step S14 that the DC power is being supplied from the second power storage device 24b to the second load device 16b (step S14: NO), the process proceeds to step S17.

In step S17, the control device 32 determines whether or not the supply of DC power from the third power storage device 24c to the third load device 16c has been cut off. In a case where it is determined that the supply of the DC power from the third power storage device 24c to the third load device 16c has been cut off (step S17: YES), the process proceeds to step S18.

In step S18, the control device 32 controls the fourth backflow allowing element 30d to allow the current backflow in the fourth power supply circuit 12d. Thereafter, the process proceeds to step S19.

In step S19, the control device 32 controls the first connection device 20a to connect the first power supply circuit 12a and the third power supply circuit 12c. Thereafter, the fail-safe control is ended.

In a case where it is determined in step S17 that the DC power is being supplied from the third power storage device 24c to the third load device 16c (step S17: NO), the process proceeds to step S20.

In step S20, the control device 32 determines whether or not the supply of DC power from the fourth power storage device 24d to the fourth load device 16d has been cut off. In a case where it is determined that the supply of the DC power from the fourth power storage device 24d to the fourth load device 16d has been cut off (step S20: YES), the process proceeds to step S21.

In step S21, the control device 32 controls the third backflow allowing element 30c to allow the current backflow in the third power supply circuit 12c. Thereafter, the process proceeds to step S22.

In step S22, the control device 32 controls the second connection device 20b to connect the second power supply circuit 12b and the fourth power supply circuit 12d. Thereafter, the fail-safe control is ended.

In a case where it is determined in step S20 that the DC power is being supplied from the fourth power storage device 24d to the fourth load device 16d (step S20: NO), the fail-safe control is ended.

### Third Embodiment

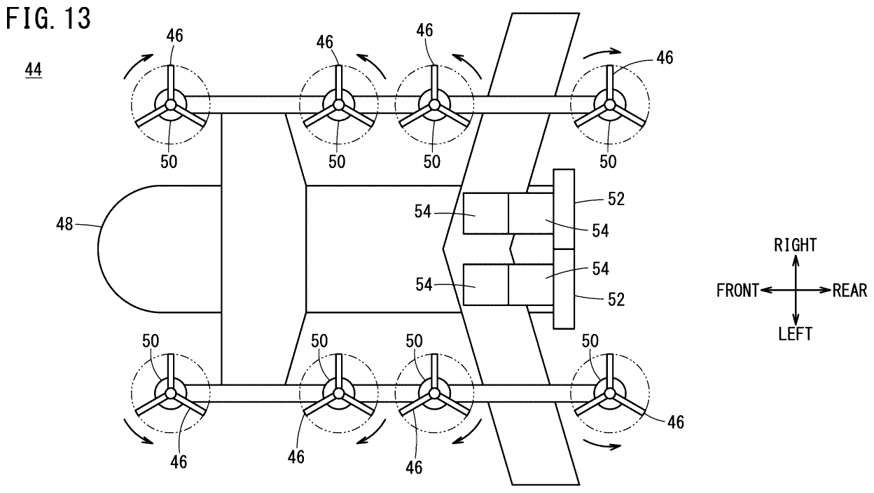

FIG. 13 is a schematic diagram of a moving object 44 according to a third embodiment. The power supply system 10 is mounted on the moving object 44 of the third embodiment.

The moving object 44 of the third embodiment is an electric vertical take-off and landing aircraft (eVTOL aircraft). The moving object 44 includes eight VTOL rotors 46. The VTOL rotors 46 generate upward thrust for a fuselage 48. The moving object 44 includes eight electric motors 50. One electric motor 50 drives one VTOL rotor 46. The moving object 44 includes two cruise rotors 52. The cruise rotors 52 generate forward thrust for the fuselage 48. The moving object 44 includes four electric motors 54. Two electric motors 54 drive one cruise rotor 52.

Each of the first load device 16a, the second load device 16b, the third load device 16c, and the fourth load device 16d may include two electric motors 50 and one electric motor 54. Each of the first load device 16a, the second load device 16b, the third load device 16c, and the fourth load device 16d may include a low-voltage drive device in addition to the electric motors 50 and the electric motor 54.

The moving object 44 is not limited to an aircraft, and may be a ship, an automobile, a train, or the like.

The following supplementary notes are further disclosed in relation to the above-described embodiments.

### Supplementary Note 1

The power supply system (10) of the present disclosure includes: the first power supply circuit (12a) configured to supply, to the first load device (16a), DC power output from the first power generation device (14a); the first power storage device (24a) connected to the first power supply circuit in parallel with the first power generation device; the second power supply circuit (12b) including the backflow preventing element (28b) configured to prevent a current backflow, and the backflow allowing element (30b) configured to allow the current backflow, the second power supply circuit being configured to supply, to the second load device (16b), the DC power output from the first power generation device; the second power storage device (24b) connected to the second power supply circuit in parallel with the first power generation device; and the control device (32) configured to control the backflow allowing element, wherein, in a case where the supply of the DC power from the first power storage device to the first load device is cut off, the control device controls the backflow allowing element to allow the current backflow in the second power supply circuit, thereby supplying the DC power to the first load device from the second power storage device via the second power supply circuit. According to this feature, even in a case where the supply of the DC power from the first power storage device to the first load device is cut off, the supply of sufficient electric power to the first load device can be continued.

### Supplementary Note 2

The power supply system according to Supplementary Note 1 may further include: the third power supply circuit (12c) configured to supply, to the third load device (16c), the DC power output from the second power generation device (14b); the third power storage device (24c) connected to the third power supply circuit in parallel with the second power generation device; and the connection circuit (18a) including the connection device (20a) configured to connect the first power supply circuit and the third power supply circuit, wherein, in a case where the supply of the DC power from the first power storage device to the first load device is cut off, the control device controls the connection device to connect the first power supply circuit and the third power supply circuit via the connection circuit, thereby further supplying the DC power to the first load device from the second power generation device. According to this feature, the degree of deterioration of the second power storage device and the degree of deterioration of the third power storage device can be substantially equal to each other.

### Supplementary Note 3

The moving object (44) of the present disclosure includes the power supply system according to Supplementary Note 1 or 2. According to this feature, even in a case where the supply of the DC power from the first power storage device to the first load device is cut off, the supply of sufficient electric power to the first load device can be continued.

### Supplementary Note 4

The control method of the power supply system of the present disclosure is a control method of the power supply system including: the first power supply circuit configured to supply, to the first load device, DC power output from the first power generation device; the first power storage device connected to the first power supply circuit in parallel with the first power generation device; the second power supply circuit including the backflow preventing element configured to prevent a current backflow, and the backflow allowing element configured to allow the current backflow, the second power supply circuit being configured to supply, to the second load device, the DC power output from the first power generation device; the second power storage device connected to the second power supply circuit in parallel with the first power generation device; and the control device configured to control the backflow allowing element, wherein, in a case where the supply of the DC power from the first power storage device to the first load device is cut off, the control device controls the backflow allowing element to allow the current backflow in the second power supply circuit, thereby supplying the DC power to the first load device from the second power storage device via the second power supply circuit. According to this feature, even in a case where the supply of the DC power from the first power storage device to the first load device is cut off, the supply of sufficient electric power to the first load device can be continued.

Although the present disclosure has been described in detail, the present disclosure is not limited to the above-described individual embodiments. Various additions, replacements, modifications, partial deletions, and the like can be made to these embodiments without departing from the gist of the present disclosure or without departing from the essence of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A power supply system comprising:
a first power supply circuit configured to supply, to a first load device, direct current electric power output from a first power generation device;
a first power storage device connected to the first power supply circuit in parallel with the first power generation device;
a second power supply circuit including a backflow preventing element configured to prevent a current backflow, and a backflow allowing element configured to allow the current backflow, the second power supply circuit being configured to supply, to a second load device, the direct current electric power output from the first power generation device;
a second power storage device connected to the second power supply circuit in parallel with the first power generation device; and
a control device configured to control the backflow allowing element, the control device comprising one or more processors that execute computer-executable instructions stored in a memory,
wherein, in a case where supply of direct current electric power from the first power storage device to the first load device is cut off, the one or more processors execute the computer-executable instructions to cause the control device to control the backflow allowing element to allow the current backflow in the second power supply circuit, thereby supplying direct current electric power to the first load device from the second power storage device via the second power supply circuit.

2. The power supply system according to claim 1, further comprising:
a third power supply circuit configured to supply, to a third load device, direct current electric power output from a second power generation device;
a third power storage device connected to the third power supply circuit in parallel with the second power generation device; and
a connection circuit including a connection device configured to connect the first power supply circuit and the third power supply circuit, wherein
in the case where the supply of the direct current electric power from the first power storage device to the first load device is cut off, the one or more processors cause the control device to control the connection device to connect the first power supply circuit and the third power supply circuit via the connection circuit, thereby further supplying the direct current electric power to the first load device from the second power generation device.

3. A moving object comprising the power supply system according to claim 1.

4. A control method of a power supply system, the power supply system including:
a first power supply circuit configured to supply, to a first load device, direct current electric power output from a first power generation device;
a first power storage device connected to the first power supply circuit in parallel with the first power generation device;
a second power supply circuit including a backflow preventing element configured to prevent a current backflow, and a backflow allowing element configured to allow the current backflow, the second power supply circuit being configured to supply, to a second load device, the direct current electric power output from the first power generation device;
a second power storage device connected to the second power supply circuit in parallel with the first power generation device; and
a control device configured to control the backflow allowing element,
the control method comprising, in a case where supply of direct current electric power from the first power storage device to the first load device is cut off, causing the control device to control the backflow allowing element to allow the current backflow in the second power supply circuit, thereby supplying direct current electric power to the first load device from the second power storage device via the second power supply circuit.
